(19) United States
(12) Patent Application Publication
(10) Pub. No.: US 2026/0274098 A1
(43) Pub. Date: Sep. 17, 2026

(54) BATTERY-BACKED CHARGER

(71) Applicant: DESIGNWERK TECHNOLOGIES AG, CH-8408 WINTERTHUR (CH)

(72) Inventors: Vivien Olivier DETTWILER, Hochwand (CH); Frank LOACKER, Islikon (CH)

(73) Assignee: DESIGNWERK TECHNOLOGIES AG, CH-8408 WINTERTHUR (CH)

(21) Appl. No.: 19/167,171

(22) PCT Filed: Mar. 21, 2024
(86) PCT No.: PCT/EP2024/057692

§ 371 Date: Sep. 19, 2025

(30) Foreign Application Priority Data
Mar. 23, 2023 (CH) CH000321/2023

(51) Int. Cl. B60L 53/302; B60L 50/64; B60L 53/16; H01M 10/42

(52) U.S. Cl. CPC B60L 53/302; B60L 50/64; B60L 53/16; H01M 10/425; B60L 2210/10; B60L 2210/30; H01M 2220/10

(57) ABSTRACT

A battery-backed charger for electric vehicles includes a grid connection interface configured to provide electrical energy from an electrical grid to the battery-backed charger and/or to transmit electrical energy to the electrical grid from the battery-backed charger. A vehicle connection interface is configured to provide electrical energy from the battery-backed charger to the electrical vehicle and/or to transmit electrical energy to the battery-backed charger from the electrical vehicle. A battery assembly includes at least one battery pack and is connected to the grid connection interface and to the vehicle connection interface. A housing contains the grid connection interface, the vehicle connection interface, and the battery assembly.

### BACKGROUND OF THE INVENTION

### Field of the Invention

The present disclosure relates to a battery-backed charger for electric vehicles, preferably of electric commercial vehicles. In particular, the present disclosure relates to a battery-backed charger for charging of electric vehicles, comprising a grid connection interface, a vehicle connection interface, a battery assembly and a housing.

### Discussion of Related Art

Passenger and freight transport are facing a profound transformation. Within the European Union for instance, commercial vehicles account for around a quarter of road transport emissions, which is equivalent to 6 per cent of all CO2 emissions. They are caused by the approximately 6.6 million trucks that are in use every day, which transport around 76.7 percent of all freight on land within the European Union. If the climate goals are to be achieved by 2030, the CO2 emissions of heavy goods traffic must be significantly reduced. This is possible by means of a wave of electrification, as is already in full swing in passenger transportation.

In long-distance and heavy goods transport, the changeover is more difficult. Currently, there are hardly any battery-electric transport vehicles in use in long-distance traffic throughout Europe. Even in continuous or shift operation, electric trucks seem less attractive. The reasons for this are the limited battery capacity and the limited charging power.

For a change in the respective segments, powerful charging infrastructure is therefore required, which is up to date not available. Further, currently available charging infrastructure is only available in the kilowatt range, which leads to long charging times of electric commercial vehicles. Further, charging stations for electric commercial vehicles are due to its current complexity very expensive and require a lot of space due to the different components arranged in different housings around a charging space for the electric commercial vehicle, thereby forming the conventional charging station.

Further, conventional charging stations for electric commercial vehicles may lead to considerable load peaks in the power grid due to the high demand, which could cause negative effects on the overall power grid.

### SUMMARY OF THE INVENTION

It is an object of the present disclosure to provide a charging station, in particular a battery-backed charger for charging of electric vehicles, preferably of electric commercial vehicles. In particular, it is an object of the present disclosure to provide a battery-backed charger for charging of electric vehicles, preferably of electric commercial vehicles not having at least some of the disadvantages of the prior art.

According to the present disclosure, a battery-backed charger for charging electric vehicles, preferably of electric commercial vehicles, is specified. The battery-backed charger preferably comprises a grid connection interface, which is configured to provide electrical energy from an electrical grid to the battery-backed charger and/or to transmit electrical energy to the electrical grid from the battery-backed charger. The battery-backed charger may further comprise a vehicle connection interface, which is configured to provide electrical energy from the battery-backed charger to the electrical vehicle and/or to transmit electrical energy to the battery-backed charger from the electrical vehicle. The battery-backed charger may further comprise a battery assembly comprising at least one battery pack and connected to the grid connection interface and to the vehicle connection interface and configured to provide an electrical energy buffer for the battery-backed charger using the at least one battery pack during its operation.

In a variation, the battery-backed charger may further comprise a housing, which contains the grid connection interface, the vehicle connection interface and the battery assembly, wherein the at least one battery pack of the battery assembly is arranged in a battery compartment of the housing, which separates the at least one battery pack from the connection interfaces arranged outside of the battery compartment.

The battery assembly comprises for example a plurality of battery packs or battery systems, which comprises a series of individual battery modules and protection systems organized in a specific shape. The battery module comprises a plurality of battery cells connected in series or in parallel. The battery cell is a single unit, which converts and stores the chemical energy into electrical energy.

The grid connection interface may comprise connection possibilities to a low voltage grid, for instance in the range of 400 Volt. Further, to a grid configured to provide less than or equal to 400 kW, to a grid configured to provide less than or equal to 88 kW and/or to a grid configured to provide less than or equal to 44 kW. The grid connection interface is therefore configured to provide the desired electrical connection of the battery-backed charger for transmitting electrical energy to the battery-backed charger and for transmitting electrical energy from the battery-backed charger to the electrical grid. The battery-backed charger may therefore be connected to a wide variety of available electrical grids, which increases the usability of the battery-backed charger.

The battery assembly, which comprises at least one battery pack, is configured to store electrical energy received from the grid connection interface and/or from the vehicle connection interface and to provide electrical energy to the grid connection interface and/or from the vehicle connection interface. The battery assembly provides therefore an energy buffer during operation of the battery-backed charger, in particular for loading of the electric vehicle via the vehicle connection interface and for providing electrical energy to the grid, preferably a local grid, for example in an emergency situation or at a construction side which is not connected to a public electric grid.

The housing of the battery-backed charger comprises or houses preferably all of the components necessary for providing the required functionalities of the battery-backed charger. In particular, the housing contains the grid connection interface, the vehicle connection interface and preferably in a separate compartment within the housing the battery assembly. The separate compartment enables that the battery assembly, comprising dangerous chemicals, is mechanically separated from the other components of the battery-backed charger, such that a dangerous situation, for instance a leak of the battery assembly would not affect the other components and vice versa. Further, this increases the fire security of the battery-backed charger, in particular because it protects the different components in the different compartments within the housing. In addition, having all necessary components of the battery-backed charger within one housing enables a relatively simple and fast handling, commissioning and maintenance of the entire battery-backed charger

Overall, the battery-backed charger according to the present disclosure enables a grid connected high power (kW to MW) charging of electric vehicles and an off-grid high power (kW to MW) charging of electric vehicles. Further, the battery-backed charger according to the present disclosure may be used to provide an island grid or to provide a buffer for a local or public electrical grid. It is, for example, possible to discharge a connected vehicle for charging the battery assembly or for directly providing electrical energy to a local or public grid. The battery assembly and/or the electric vehicle may be used as buffer/provider of electrical energy. Further, the battery-backed charger enables to transfer electrical energy from one vehicle connected via the vehicle connection interface to the battery-backed charger to another vehicle connected via the vehicle connection interface to the battery-backed charger. The battery-backed charger may further provide a local grid, such that electrical consumers may be directly connected to the battery-backed charger, which supplies via the battery assembly, a connected grid and/or a connected electrical vehicle electrical energy to the electrical consumer. In other words, the battery-backed charger is configured such that a flow of electrical energy is not direction dependent, instead the electrical energy may flow within the components of the battery-backed charger both available directions (bidirectional) for enabling all of the mentioned used cases.

The battery-backed charger is for example configured to provide a power output of a range from 300 kW to 3000 kW, preferably of 350 kW to 2100 kW for charging of the electric vehicle and/or for a connected (local) power grid. The battery-backed charger is further for example configured to provide electrical power to the electric vehicle and/or to the connected (local) power grid having a voltage in a range of 350 V to 1250 V, preferably in a range of 500 V to 900 V. The battery-backed charger is further for example configured to provide electrical power to the electric vehicle and/or to the connected (local) power grid having an electrical current in a range of 0 A to 5.000 A, preferably in a range of 0 A to 3.000 A. This high flexibility enables to charge all different kind of electric vehicles from small electric cars to electric ships, for example ferries.

An advantageous transportation of the battery-backed charger is realizable, when the overall weight of the battery-backed charger is in a range from 5.000 kg to 35.000 kg, preferably in a range from 18.000 kg to 25.000 kg. Having the mentioned overall weight enables an advantageous transportation of the battery-backed charger via for example a conventional commercial vehicle.

It is preferred that the grid connection interface comprises an electrical interface line configured to connect the electrical grid to the battery assembly and the vehicle connection interface. The electrical interface line is an electrical line comprising several different electrical components, which are connected to each other, preferably in series. The interface electric line comprises a low voltage connector configured to connect the electrical interface line with a low voltage (local and/or public) grid. The low voltage connector comprises, for example, a plurality of connectors, which are configured to be connected to different kind of electrical grids. The plurality of connectors are for example switchable interconnected with each other such the available connection can be combined. The interface electric line further preferably comprises a transformer, connected to the low voltage connector and configured to transform the alternative current received from the low voltage connector. The transformer is preferably a delta transformer, a star transformer or a delta-star transformer. The transformer is for example configured to transform a received electrical voltage from 400 V to 500 V or vice versa. The interface electric line further preferably comprises an AC/DC converter, connected to the transformer and configured to convert the received alternating current to a direct current. The AC/DC converter is for example configured to transform received 500 V alternating current to 865-900 V direct current or vice versa. The interface electric line further preferably comprises an interface DC/DC converter, connected to the AC/DC converter and configured to convert the received alternating current having a first voltage to an alternating current having a second voltage. The interface DC/DC converter is for example configured to convert the received direct current having a voltage of 865-900 V direct current to 850-865 V direct current. The interface electric line may further comprise an LC-Filter, comprising inductors (L) and capacitors (C), which is configured to cur or pass specific frequency bands during operation of the battery-backed charger. The LC-Filter is preferably arranged between the transformer and the AC/DC converter. The interface electric line may further comprise a coil element, which is preferably arranged between the interface DC/DC converter and the battery assembly/the vehicle connection interface. The coil element may be configured to function as a sinus filter, which reduces interference signals. The electrical interface line enables that received electrical energy having specific properties is advantageously transmitted and transformed from the vehicle interface and the battery assembly to the electrical grid and/or vice versa. The electrical interface line having the described components enables advantageously the transfer of energy in both directions.

It is preferred that the grid connection interface, comprises a plurality of the interface electrical lines each being configured to connect the electrical grid to the battery assembly and the vehicle connection interface, and each comprising the low voltage connector, the transformer, the AC/DC converter and/or the interface DC/DC converter. The plurality of interface electrical lines is preferably arranged in parallel with respect to each other, thereby separately connecting the electrical grid to the battery assembly and/or the vehicle connection interface. Having a plurality of interface electrical lines enables that the possible energy transfer is increased.

In a preferred variation, the battery assembly comprises an electrical battery line configured to connect the battery assembly to the grid connection interface and the vehicle connection interface. The electrical battery line is an electrical line comprising several different electrical components, which are connected to each other, preferably in series, such that bidirectional energy transfer is enabled. The connection of the electrical battery line enables that electrical energy is received by the battery assembly, for charging of the battery pack, from the grid connection interface (via the at least one interface electrical line) and/or from the vehicle connection interface. The connection of the electrical battery line enables further that electrical energy is transmitted by the battery assembly, to the grid connection interface (via the at least one interface electrical line) and/or to the vehicle connection interface. The electrical battery line preferably comprises a battery DC/DC converter, connected to the grid connection interface and to the vehicle connection interface and configured to convert the received alternating current having a first voltage to an alternating current having a second voltage. The DC/DC converter is for example configured to convert received 850V-865V direct current to 300V-450V direct current. The DC/DC converter enables that the electrical current received from the electrical grid and/or the vehicle connection interface is converted to the desired range for the battery pack and vice versa. The electrical battery line further comprises at least one battery pack, connected to the battery DC/DC converter, and configured to store received electrical energy via the battery DC/DC converter and/or configured to provide electrical energy via the battery DC/DC converter to the grid connection interface and/or to the vehicle connection interface. The at least one battery pack is preferably exchangeable interconnected to the DC/DC converter, such that the individual battery pack is advantageously replaceable, even during operation of the battery-backed charger. It is preferred that the battery packs have a voltage band of 300-450 V and/or a capacity in a range from 0.4 MWh to 2.5 MWh alone or combined, preferably in a range from 0.45 MWh to 1.8 MWh alone or combined. It may be that different battery packs have, for example due to their individual age, a varying available voltage and/or capacity. The different battery packs may further have different states of charge. Further, the electrical battery line may comprise a coil element arranged between the battery pack and the DC/DC converter. The coil element may be configured to function as a sinus filter, which reduces interference signals from the battery DC/DC converter. Overall, the electrical battery line enables that different available battery packs can be used in the battery-backed charger. It is for example preferred that the battery packs are replaced battery packs from electric commercial vehicles, in other words, the battery packs may are second life battery packs. One battery pack may further be configured to provide permanent current of 330 A and/or 660 A and/or 990 A and so on.

In a variation, the battery assembly comprises a plurality of electrical battery lines, preferably in a range from five to twenty, even more preferably eight or sixteen electrical battery lines, each comprising a respective battery DC/DC converter at least one battery pack, and each being configured to connect the battery assembly to the grid connection interface and the vehicle connection interface. This variation enables that a plurality of battery packs, having for example different capacities, are advantageously connectable to the vehicle connection interface and the electrical grid, via the DC/DC converter. It is preferred that the battery assembly comprising the plurality of electrical battery lines with the respective battery pack provides a capacity in a range from 0.4 MWh to 2.5 MWh, preferably in a range from 0.45 MWh to 1.8 MWh.

In a preferred variation, a first electrical interface line is connected to a first electrical battery line and a second electrical interface line is connected to a second electrical battery line. This variation enables that the energy transfer is advantageously divided among the available electrical battery lines and electrical interface lines. It is preferred that additional electrical battery lines are alternating connected to the first and the second electrical interface line. In a further variation, the connection between the electrical interface lines and the electrical battery lines is switchable, such that depending on the current used case of the battery-backed charger and/or properties (SoC, capacity etc.) of the battery packs, the advantageous battery line is connected to the electrical interface line.

The vehicle connection interface may comprise a vehicle interface line comprising at least one charging interface, which is configured to be connected to the electric vehicle. The vehicle interface line may further be connected to the electrical interface line(s), enabling the energy transfer between the battery assembly and the vehicle connection interface and the grid connection interface and the vehicle connection interface.

In a preferred variation, the battery assembly has a modular structure such that each battery pack of the battery assembly is exchangeable connected to the battery-backed charger, in particular to the respective battery DC/DC converter, such that it is exchangeable without removing or exchanging another battery pack from the battery assembly. Advantageously, the battery assembly is configured such that changing of one or a plurality of battery packs of the battery assembly is doable during operation of the battery-backed charger.

Safety requirements are advantageously achievable when at least one of the electrical components, for instance the low voltage connector, the transformer, the LC-Filter, the AD/DC converter, the interface DC/DC converter and/or the coil element of the at least one electrical interface line is or are arranged in the housing in a separate compartment, in particular in a from the battery compartment different compartment. In other words, the housing of the battery-backed charger comprises besides the battery compartment an additional compartment, for example an interface compartment, which comprises or houses the above-mentioned components. The separation enables that safety critical events within one compartment do not affect the other compartment.

Safety requirements are advantageously achievable when the battery DC/DC converter and/or the coil element of the at least one electrical battery line is arranged in the housing in a from the battery compartment different compartment In other words, the housing of the battery-backed charger comprises besides the battery compartment an additional compartment, for example an interface compartment, which comprises or houses the above-mentioned components. The separation enables that safety critical events within one compartment do not affect the other compartment. It is preferred that the electrical components of the interface electrical line are arranged in the same compartment (interface compartment) as the electrical components of the electrical battery line named above, besides the battery packs, which are arranged in the battery compartment.

In a preferred variation, the battery-backed charger comprises a cooling assembly arranged preferably in a cooling compartment within the housing, wherein the cooling assembly is configured to regulate a temperature of at least one part of the battery-backed charger, preferably of the battery assembly and/or of the components of the at least one electrical interface line and/or of the at least one electrical battery line, during operation of the battery-backed charger. In particular, the battery packs work advantageously if they are kept, during operation, within their preferred optimal temperature range, in particular in the range from −30° C. to +55° C., preferably in the range from −20° C. to +45° C. The same applies to the above-mentioned electrical components of the at least one electrical interface line and of the at least one electrical battery line. Arranging the cooling assembly in a separate compartment within the housing advantageously increases the accessibility and the maintainability. Further, safety critical events within the cooling compartment, for example a leak of coolant do not affect the electrical components arranged within another compartment.

It is preferred that the cooling assembly comprises a heat exchanger, configured to provide a controlled exchange of heat from a cooling fluid to a ventilation fluid, preferably air, within the cooling compartment, which is configured to absorb the heat from the cooling fluid during operation of the battery-backed charger. The cooling fluid is preferably configured to cool the battery assembly, in particular the battery packs and/or electrical components of the electrical interface line and/or of the electrical battery line during operation of the battery-backed charger. The cooling assembly may further comprise at least one ventilator, configured to provide a controlled exchange of the ventilation fluid within the cooling compartment with a surrounding environment of the battery-backed charger. The ventilator is preferably arranged such on or within the housing of the battery-backed charger that it enables and forces air exchange between the surrounding of the battery-backed charger and the interior of the cooling compartment. The housing preferably has a cooling opening for facilitating the fluid/air exchange.

It is preferred that the cooling assembly may further be configured to guide coolant to the charging interface of the vehicle connection interface for cooling the charging interface during its operation.

In a preferred variation, the battery compartment is arranged in the housing between the cooling compartment and an interface compartment, which comprises the connection interfaces. The battery compartment is arranged in the middle of the housing, which enables advantageous access to the battery compartment thereby enabling advantageous access for changing/replacing of the battery packs of the battery assembly. Further, this arrangement of this variation enables that the cooling pipes arranged between the cooling compartment and the battery compartment are kept as short as possible and at the same time the electric cable connections between the battery compartment and the interface compartment comprising the electronic components of the electrical interface line etc. are kept as short as possible. Overall, this arrangement increases the efficiency of the battery-backed charger.

An advantageous access to the different compartments of the housing is realizable if the housing of the battery-backed charger provides a separate access to the individual compartments of the housing from outside through the housing, in particular through outer walls of the housing. The separate access to the individual compartments is for example realized by doors, which are preferably arranged on the sidewalls of the housing. In a preferred variation, the doors enable maintenance personnel to enter the respective compartment. It is preferred that the cooling compartment and/or the interface compartment comprises a walkable space, which enables for example maintenance personnel to enter and move within the respective compartment which improves the maintainability of the entire battery-backed charger.

An advantageous robust and transportation friendly battery-backed charger is realizable when the housing has at least partially a cubical shape, preferably a shape of a container, even more preferably the shape of a shipment container. The housing of the battery-backed charger has for example at least partially external dimensions of an ISO container, in particular having a length in the range from 6 m to 12.5 m, preferably 6.058 m or 12.192 m, having a width in the range from 2 m to 2.5 m, preferably 2.438 m and/or having a height in the range from 2 m to 3 m, preferably of 2.591 m.

The housing preferably comprises dedicated contacting points or surfaces, preferably arranged in the corner of the housing, for contacting a foundation of a surrounding. The dedicated contacting points may further at least partially comprise, preferably at least at the top of the housing, anchor points, which are advantageously used for transportation of the battery-backed charger.

In a preferred variation, the vehicle connection interface comprises a plurality of charging interfaces, preferably two charging interfaces using the MCS-standard and/or two charging interfaces using the CCS-standard, preferably CCS type 2. The MCS-standard (Megawatt Charging System) is used for high-speed megawatt charging preferably of commercial vehicles. The CCS-standard (combined charging system) is used for charging electric vehicles. The vehicle connection interface may further comprise charging interfaces using different international standards, for instance CHAdeMO or ChaoJi. According to this variation, it is for example possible to connect an electric vehicle using the MCS-Standard and an electric vehicle using the CCS-standard at the same time for charging/discharging.

In a variation, at least one of the charging interfaces is liquid cooled, preferably using coolant from the cooling assembly.

Electrical (commercial) vehicles include, for example, electric cars, electric commercial trucks, electric ships, electric aircrafts and other electric vehicles.

In a preferred variation, the battery-backed charger comprises a grid switching arrangement, which is configured to selectively couple or uncouple the available electrical grids, and/or a vehicle switching arrangement, which is configured to selectively couple or uncouple components of the battery-backed charger for a desired electrical energy transfer between the battery-backed charger and the electrical vehicle. The grid switching arrangement preferably comprises a plurality of electric switches, which are arranged between the different low voltage grid connectors and the transformers of the respective electrical interface lines. The grid switching arrangement may form part of the at least one electrical interface line. The grid switching arrangement further comprises a respective wiring, which enables that the available electric power from the connected electric grid can be combined and transferred to the battery assembly or to the vehicle connection interface, via the at least one electrical interface lines, and vice versa.

The vehicle switching arrangement preferably comprises a plurality of electric switches, which are arranged between the different charging interfaces and the connection electrical interface line(s). The vehicle switching arrangement may form therefore part of the vehicle connection interface, in particular of the at least one vehicle interface line. The vehicle switching arrangement may further comprise a respective wiring, which enables that the different vehicle interface lines are interconnected, such that an advantageous fast energy transfer from the battery assembly and/or the grid connection interface to the respective charging interfaces of the vehicle connection interface is realizable.

In a variation, the battery-backed charger further comprises a control unit, which is configured to control the different electrical components of the at least one electrical interface line, the electrical components of at least one battery line and/or the electrical components of the at least one vehicle interface line. In particular, the control unit is configured to control the switches of the battery-backed charger such that an advantageous electrical energy transfer between the electrical grid and the electric vehicle is realizable.

In a variation, the housing of the battery backed charger may comprise openings or connection points, which are configured for connecting pipes for transporting extinguishing water. The openings in the housing enable an advantageous connection of the respective pipes on site such that during an emergency situation extinguishing water or fluid is advantageously introduced into the housing for extinguishing a possible fire. The housing may further comprise internal pipes, which are configured to distribute the extinguishing water or fluid within the different compartments such that all compartments are advantageously reachable by the extinguishing water or fluid in an emergency situation. The battery-backed charger may further comprise an extinguishing mechanism, which automatically and/or selectively releases the extinguishing water or fluid in case a fire or an emergency situation is detected in the housing, in particular in the respective compartment within the housing.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF SEVERAL VIEWS OF THE DRAWINGS

The herein described disclosure will be more fully understood from the detailed description given herein below and the accompanying drawings, which should not be considered limiting to the disclosure described in the appended claims.

FIG. 1 shows a first perspective view of a battery-backed charger according to a first exemplary variation;

FIG. 2 shows a first top view of the variation of the battery-backed charger according to the first exemplary variation;

FIG. 3 shows a first longitudinal section view of the battery-backed charger according to the first exemplary variation;

FIG. 4 shows a second top view of the variation of the battery-backed charger according to the first exemplary variation, in particular showing section planes;

FIG. 5 shows a first cross section view of the battery-backed charger along section plane L-L as shown in FIG. 4;

FIG. 6 shows a second cross section view of the battery-backed charger along section plane T-T as shown in FIG. 5;

FIG. 7 shows a front view of the battery-backed charger according to the first exemplary variation;

FIG. 8 shows a second longitudinal section view of the battery-backed charger according to the first exemplary variation along the section plane S-S as shown in FIG. 7;

FIG. 9 shows a second perspective view of the battery-backed charger according to the first exemplary variation; and

FIG. 10 shows a block circuit diagram of a battery-backed charger according to an exemplary variation.

### DETAILED DESCRIPTION OF THE INVENTION

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, reference numbers will be used to refer to components or parts.

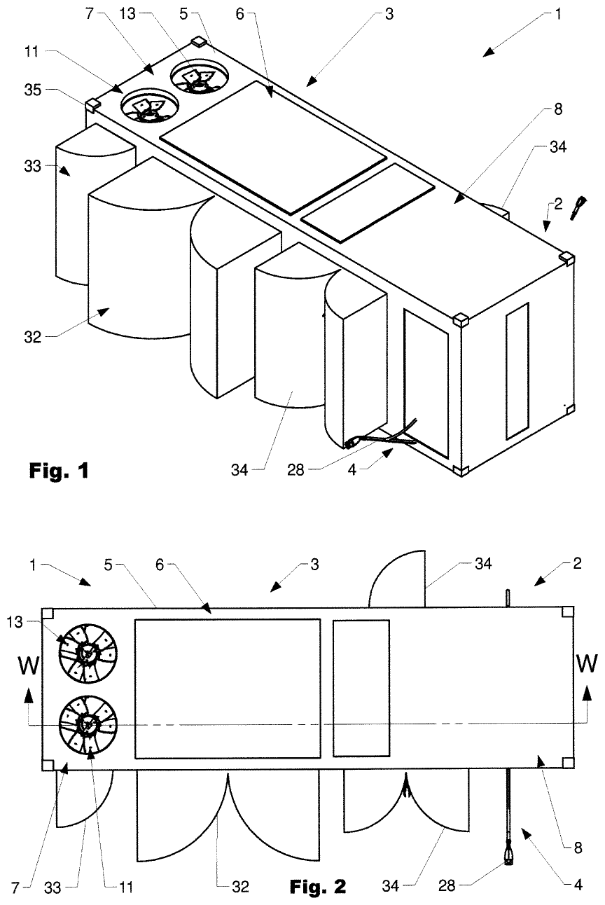

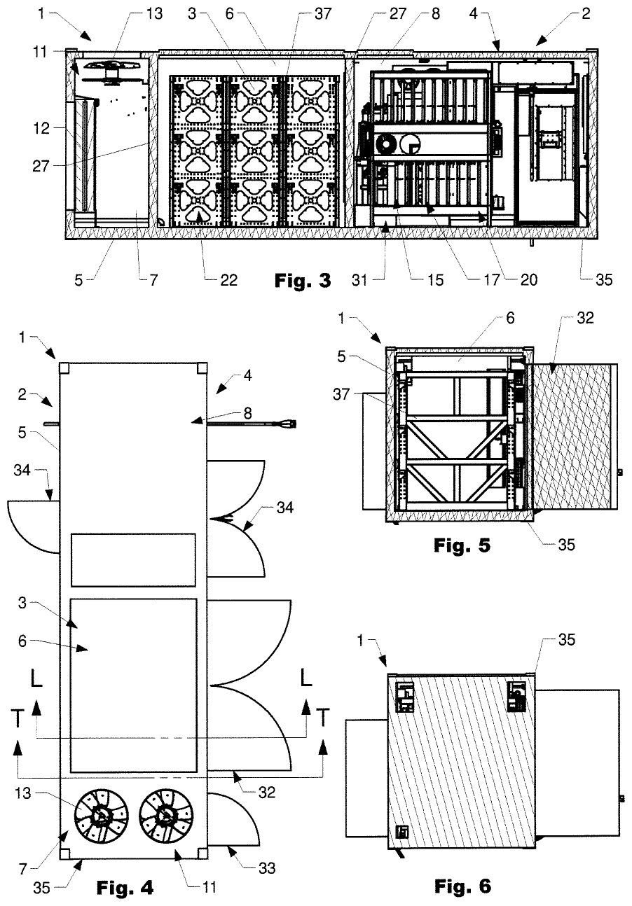

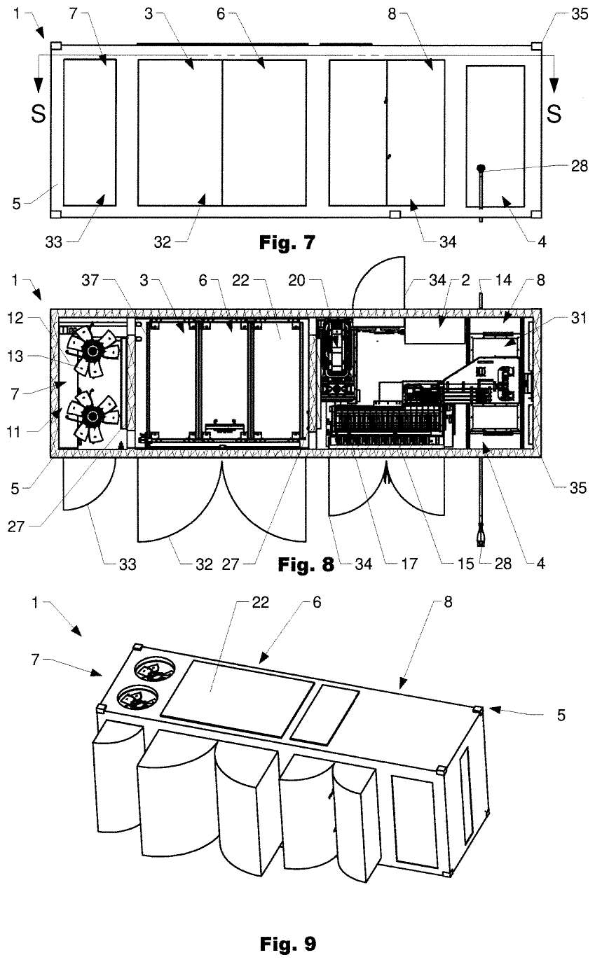

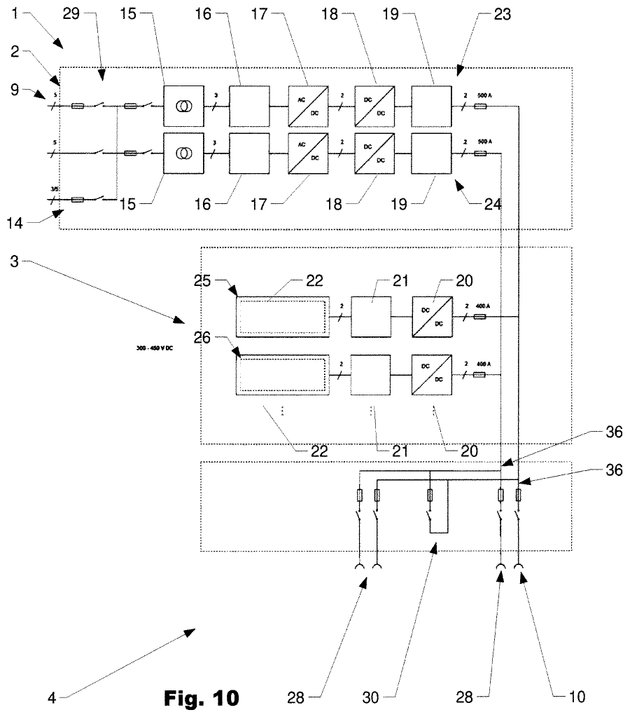

FIG. 1 shows a first perspective view of a battery-backed charger according to a first exemplary variation. FIG. 2 shows a first top view of the variation of the battery-backed charger according to the first exemplary variation. FIG. 3 shows a first longitudinal section view of the battery-backed charger according to the first exemplary variation. FIG. 4 shows a second top view of the variation of the battery-backed charger according to the first exemplary variation, in particular showing section planes. FIG. 5 shows a first cross section view of the battery-Based backed charger along section plane L-L as shown in FIG. 4. FIG. 6 shows a second cross section view of the battery-backed charger along section plane T-T as shown in FIG. 5. FIG. 7 shows a front view of the battery-backed charger according to the first exemplary variation. FIG. 8 shows a second longitudinal section view of the battery-backed charger according to the first exemplary variation along the section plane S-S as shown in FIG. 7. FIG. 9 shows a second perspective view of the battery-backed charger according to the first exemplary variation. FIG. 10 shows a block circuit diagram of a battery-backed charger according to an exemplary variation.

FIG. 1, FIG. 2 and FIG. 4 advantageously show a battery-backed charger 1 according to a first variation of the present disclosure from the outside. The battery-backed charger 1 comprises a grid connection interface 2, a battery assembly 3 and a vehicle connection interface 4. The mentioned battery assembly 3 and the interfaces 2, 4 are arranged (mainly) within a housing 5 of the battery-backed charger 1. The housing 5 as shown in the Figures, in particular in FIGS. 1 and 2, has the shape of a container 35. The housing 5 comprises, for example a battery compartment 6 comprising (mainly) the battery assembly 3, an interface compartment 8 comprising (mainly) the grid connection interface 2 and (mainly) the vehicle connection interface 4. The battery-backed charger 1 may further comprise a cooling assembly 11, which is arranged (mainly) in a cooling compartment 7 of the housing 5. The Figures show that the battery compartment 6 is arranged between the cooling compartment 7 and the interface compartment 8, thereby separating both from each other. The different compartments increase the safety of the battery-backed charger 1 during its operation. FIGS. 1 and 2 further show ventilators 13, which form part of the cooling assembly 11, which facilitate air exchange between the cooling compartment 7 and the surrounding environment of the battery-backed charger 1. FIG. 1 and FIG. 2 further advantageously show schematically a charging interface 28, configured to be connected to an electric vehicle 10 (schematically shown in FIG. 10) and configured to provide an energy transfer between the battery-backed charger 1 and the electric vehicle 10. The Figures further advantageously show openings in the housing 5, which enable entering into the different compartments of the battery-backed charger 1. The housing 5 comprises a battery compartment opening 32 configured to enable access to the battery compartment 6, a cooling compartment opening 33, configured to enable access to the cooling compartment 7 and an interface compartment opening 34, configured to enable access to the interface compartment 8. The interface compartment opening 34 as shown in the Figures comprises two doors arranged on opposite sides of the housing 5, which enable both access to the interface compartment 8. FIG. 2 further indicates a section plane W-W.

FIG. 3 shows a longitudinal section view along the section plane W-W as indicated in FIG. 2. FIG. 3 advantageously shows the different compartments within the housing 5. FIG. 3 shows in particular that the cooling compartment 7 is separated from the battery compartment 6 by a solid wall 27 and that the interface compartment 8 is also separated from the battery compartment 6 by a solid wall 27. The solid separating walls 27 extend from the bottom of the housing 5 until the top of the housing 5. FIG. 3 further advantageously shows the cooling assembly 11 comprising a heat exchanger 12 and the ventilator 13. The heat exchanger 12 is configured to exchange heat from a coolant to air within the cooling compartment. FIG. 3 further advantageously shows that the housing 5 around the cooling compartment 7 comprises at the top an opening enabling air exchange between the cooling compartment 7 and the surrounding environment. The ventilator 13 facilitates air exchange such that the temperature within the cooling compartment 7 stays within the desired temperature range. The coolant of the heat exchanger 12 is configured to flow during operation between the battery compartment 6 and/or the interface compartment 8 and the heat exchanger 12, thereby cooling the electrical components of the battery assembly 3 and/or the interfaces 2, 4.

FIG. 3 further advantageously shows the assembly of battery packs 22 of the battery assembly 3. The battery packs 22 are stacked among each other in a 3 by 3 formation. FIG. 3 further shows a support structure 37, in which the battery packs 22 are inserted. The support structure 37 may enable that coolant from the cooling assembly 11 to flow advantageously along the different battery packs 22 during operation. The support structure 37 and/or the battery packs 22 may provide coolant channels for the coolant, such that the released heat is advantageously removed during operation. The support structure 37 may further be configured such that at least one of the battery packs 22 is exchangeable from the battery assembly 3 without removing or displacing another one of the battery packs 22. The battery compartment opening 32 may have at least the size of the front of the battery assembly 3, such that each one of the battery packs 22 is insertable and removable from the battery assembly 3, in particular the support structure 37, through the battery compartment opening 32, best visible in FIG. 2 and FIG. 8.

FIG. 3 further indicates different electrical components of the grid connection interface 2 and the vehicle connection interface 4 of the battery-backed charger 1 arranged in the interface compartment 8, thereby advantageously separated within the housing 5 from the battery assembly 3. FIG. 3 indicates, for example, transformers 15, AC/DC converter 17, DC/DC converter 20 arranged within the interface compartment 8.

FIG. 4 further shows cross section planes L-L and T-T. FIG. 5 shows the respective cross section view along the section plane L-L and FIG. 6 shows the respective cross section view along the section plane T-T.

FIG. 5 advantageously shows the cross section along the battery compartment 6 of the housing 5, showing the support structure 37 for the battery packs 22, which enables that the different battery packs 22 are stacked among and next to each other. FIG. 5 further shows the battery compartment opening 32.

FIG. 6 advantageously shows the cross section T-T along the solid wall 27 between the battery compartment 6 and the cooling compartment 7. The wall 27 comprises openings on both top edges and on one bottom edge. The rest of the wall 27 is in this variation made of solid material, preferably metals or plastics. The walls 27 between the compartments are preferably made of the same material as the housing 5. The openings in the walls 27 as best visible in FIG. 6 enable that coolant pipes are guided from the cooling compartment 6, in particular from the heat exchanger 12, to the battery compartment 6, in particular to the battery packs 22, and/or further to the interface compartment 8. The openings may further enable that electric wires are guided between the cooling compartment 7 and the battery compartment 6.

The wall 27 separating the battery compartment 6 and the interface compartment 8 may further comprise openings enabling to guide coolant pipes and/or electric wires between the two compartments. The openings are preferably arranged on the top edges of the wall 27. The walls 27 thereby form part of the housing 5.

The wall 27 between the battery compartment 6 and the interface compartment 8 may have the same properties as the wall 27 between the battery compartment 6 and the cooling compartment 7. The walls 27 are for example made of a fireproof material, thereby providing advantageous fire-safety properties for the battery-backed charger 1.

FIG. 7 advantageously shows as front view the different openings of the housing 5, in particular of the battery compartment opening 32, the cooling compartment opening 33 and the interface compartment opening 34. These openings are further also shown in detail in FIG. 8. FIG. 7 further shows the longitudinal section plane S-S.

FIG. 8 shows the longitudinal section view from the top down to the bottom of the battery-backed charger 1 along the section plane S-S as presented in FIG. 7. The longitudinal section view of FIG. 8 shows advantageously the battery compartment 7 arranged between the cooling compartment 7 and the interface compartment 8 separated by the solid walls 27. FIG. 8 also shows the openings in the walls 27, which enable for example that cables, wires or pipes can be guided between the different compartments. FIG. 8 further indicates different electrical components within the interface compartment 8, for example the transformers 15, AC/DC converter 17 and the battery DC/DC converter 20. FIG. 8 indicates that several of the electrical components are located such within the interface compartment 8 that an exchange of these components is enabled from outside, via the interface compartment opening 34. FIG. 8 further shows that the second interface compartment opening 34 enables that personal, for example maintenance personal, can enter the interface compartment 8. The interface compartment 8 comprises therefore a walkable space inside, which advantageously enables that all of the arranged electrical components are reachable. Similarly, the cooling compartment opening 33 enables that personnel can enter the cooling compartment 7. The cooling compartment 7 comprises also a walkable space inside. FIG. 8 further indicates schematically the low voltage connector 14, configured to be connected to an electrical grid 9 and a charging interface 28, configured to be connected to the electrical (commercial) vehicle 10.

FIG. 9, similarly as FIG. 1, shows a second perspective view of the battery-backed charger 1 according to the first exemplary variation in partially transparent manner. FIG. 9 advantageously shows the different compartments 6, 7, 8 of the battery backed charger 1. The battery assembly 3 as shown in FIG. 9 comprises eight battery packs 22 arranged in the support structure 37. FIG. 9 further advantageously shows the simple exchangeability of the battery packs 22 through the battery compartment opening 32 and the simple exchangeability and maintainability of the electrical components of the interface compartment 8 either through the interface compartment opening 34 or the walkable space in the interface compartment 8. The same applies to the cooling compartment 7.

FIG. 10 shows a block circuit diagram of the battery-backed charger 1 according to an exemplary variation. The block circuit diagram may be subdivided in the grid connection interface 2, the battery assembly 3 and a vehicle connection interface 4. The battery-backed charger 1 as shown in FIG. 10 is connected to at least one electric vehicle 10 and is connected to an electric grid 9.

The battery assembly 3 comprises two electrical battery lines 25, 26, in particular a first electrical battery line 25 and a second electrical battery line 26. Further battery lines, for example, eight or sixteen are also conceivable and are indicated by the dots arranged below the second electrical battery line 26. The electrical battery lines 25, 26 comprise each a battery DC/DC converter 20, a battery coil element 21 and a battery pack 22. The DC/DC converter 20 is configured to convert received DC current having a specific voltage from the battery pack 22 and/or the grid connection interface 2 and/or the vehicle connection interface 4 into DC current having another specific voltage. The DC/DC converter 20 is configured to convert received current bidirectional. The battery pack 22 is configured to store received electrical energy from the DC/DC converter 20 and to emit electrical energy to the DC/DC converter 20 and further towards the electrical vehicle 10 and/or the electrical grid 9. The battery coil element 21 is for example configured to smoothen the energy transfer. Each battery pack 22 of the battery assembly 3 may be configured to provide electrical current in the range from 300 V to 450 V having a permanent current of, for example, 330 A or 660 A.

The grid connection interface 2 comprising two electrical interface lines 23, 24 comprising several electrical components. The grid connection interface 2 is configured to connect the battery-backed charger 1 with the electrical grid 9 or with the plurality of available electrical grids 9 and is further configured to transform the electrical current streaming through the grid connection interface 2. The grid connection interface 2 comprises according to this variation a low voltage connector 14 comprising three low voltage connection possibilities such that for example a low voltage grid of 400 V AC 400 kW, a low voltage grid of 400 V AC 88 KW and/or a low voltage grid of 400 V AC 44 KW is connectable to the grid connection interface 2. The grid connection interface 2 further comprises a grid switching arrangement 29, which comprises several controllable switches enabling that the connected electrical grids 9 are switchable. The grid switching arrangement 29 is further configured to control along which electrical interface line 23, 24 electrical current flows during operation of the battery-backed charger. The grid switching arrangement 29 further enables that the different electrical grids 9 may be interconnected with each other. According to this variation, the first electrical interface line 23 and the second electrical interface line 24 comprise the same electrical components, in particular a transformer 15, a LC-filter 16, an AC/DC converter 17, an interface DC/DC converter 18 and a coil element 19. The transformer 15 is for example a delta and/or a star transformer and is configured to transform bidirectional the received current. The LC-filter 16 comprises inductors (L) and capacitors (C) and is configured to cur or pass specific frequency bands during operation of the battery-backed charger 1. The LC-Filter 16 is preferably arranged between the transformer 15 and the AC/DC converter 17. The AC/DC converter 17 is configured to convert received alternating current into direct current or vice versa, for example from 500 V AC to 900 V DC or vice versa. The interface DC/DC converter 18 is configured to convert/transform bidirectional-received direct current having a specific voltage into direct current having another specific predefined voltage. The coil element 18 is for example configured to smoothen electrical current flowing through it.

The vehicle connection interface 4 comprises two vehicle interface lines 36, which are interconnected with each other via a vehicle switching arrangement 30 comprising several controllable switches. The vehicle connection interface 4 comprises two charging interfaces 28, each comprising two charging possibilities. The first charging interface 28 is a charging interface using the MCS standard, in particular for electric commercial vehicles 10. The second charging interface 28 is a charging interface using the CCS standard, in particular for electric cars.

The grid connection interface 2, the battery assembly 3 and the vehicle connection interface 4 may further comprise resistors, in particular switchable resistors, which may further enable the desired functionality of the battery-backed charger 1.

FIG. 10 further advantageously shows the interconnections between the grid connection interface 2, the battery assembly 3 and the vehicle connection interface 4. FIG. 10 shows in particular that the first electrical interface line 23 is connected to the first electrical battery line 25 and to a vehicle interface line 36. The second electrical interface line 24 is connected to the second electrical battery line 26 and to another vehicle interface line 36. Both vehicle interface lines 36 have switchable connections to the respective charging interfaces 28. Additional battery lines (indicated in FIG. 10 by dots below the second electrical battery line 25) are for example connected alternating to the first or second electrical interface line 23, 24.

The battery-backed charger 1 may further comprise a control unit 31, indicated for example in FIG. 3 or 8, which is configured to control the functionality of the battery backed charger 1. The control unit 31 is for example, in particular configured to control the grid switching arrangement 29 and the vehicle switching arrangement 30, in particular the respective switches, based on the desired use case of the battery-backed charger 1. Further, the control unit 31 may be configured to control the other electrical components of the grid connection interface 2, the battery assembly 3 and the vehicle connection interface 4.

The battery-backed charger 1 according to the variation of FIG. 10 enables a grid connected high power (MW) charging of electric vehicles 10 and an off-grid high power (MW) charging of the electric vehicles 10. Further, the battery-backed charger according to the present disclosure may be used to provide an island grid or to provide a buffer for a local or public electrical grid 9. It is for example possible to discharge a connected vehicle for charging the battery assembly 3 or for directly providing electrical energy to a local or public grid 9. The battery assembly 3 and/or the electric vehicle 10 may be used as buffer and/or provider of electrical energy. Further, the battery-backed charger 1 enables to transfer electrical energy from one vehicle 10 connected via the vehicle connection interface 4 to the battery-backed charger 1 to another vehicle 10 connected via the vehicle connection interface 4 to the battery-backed charger 1. The battery-backed charger 1 may further provide an island local grid, such that electrical consumers may be directly connected to the battery-backed charger 1, which supplies via the battery assembly 3, a connected grid and/or a connected electrical vehicle 10 electrical energy. In other words, the battery-backed charger 1 is configured such that a flow of electrical energy is not direction dependent, instead the electrical energy may flow within the components of the battery-backed charger 1 along both available directions, bidirectional for enabling all of the used cases.

1-16. (canceled)

17. A battery-backed charger for electric vehicles, the battery-backed charger comprising:
a grid connection interface configured to provide electrical energy from an electrical grid to the battery-backed charger and to transmit electrical energy to the electrical grid from the battery-backed charger;
a vehicle connection interface configured to provide electrical energy from the battery-backed charger to the electrical vehicle and to transmit electrical energy to the battery-backed charger from the electrical vehicle;
a battery assembly comprising at least one battery pack and connected to the grid connection interface and to the vehicle connection interface and configured to provide an electrical energy buffer for the battery-backed charger using the at least one battery pack during its operation.

18. The battery backed charger according to claim 17, wherein the battery backed charger further comprises a housing, which contains the grid connection interface, the vehicle connection interface and the battery assembly, wherein the least one battery pack is arranged in a battery compartment of the housing thereby separating the least one battery pack from the connection interfaces.

19. The battery-backed charger according to claim 17, wherein the grid connection interface comprises an electrical interface line configured to connect the electrical grid to the battery assembly and the vehicle connection interface, the interface electric line comprising at least one of:
a low voltage connector configured to connect the electrical interface line with a low voltage grid;
a transformer, connected to the low voltage connector and configured to transform the alternative current received from the low voltage connector;
an AC/DC converter, connected to the transformer and configured to convert the received alternating current to a direct current; or
a DC/DC converter, connected to the AC/DC converter and configured to convert the received alternating current having a first voltage to an alternating current having a second voltage.

20. The battery-backed charger according to claim 19, wherein the grid connection interface comprises a plurality of the interface electrical lines each configured to connect the electrical grid to the battery assembly and the vehicle connection interface, and each comprising at least one of: the low voltage connector, the transformer, the AC/DC converter, and the DC/DC converter.

21. The battery-backed charger according to claim 17, wherein the battery assembly comprises an electrical battery line configured to connect the battery assembly to the grid connection interface and the vehicle connection interface, the electrical battery line comprising:
a battery DC/DC converter, connected to the grid connection interface and to the vehicle connection interface and configured to convert the received alternating current having a first voltage to an alternating current having a second voltage; and
the at least one battery pack, connected to the battery DC/DC converter, and configured to store received electrical energy via the battery DC/DC converter and/or configured to provide electrical energy via the battery DC/DC converter to the grid connection interface and/or to the vehicle connection interface.

22. The battery-backed charger according to claim 21, wherein the battery assembly comprises a plurality of electrical battery lines, each comprising the respective battery DC/DC converter and the respective battery pack.

23. The battery-backed charger according to claim 20, wherein a first electrical interface line is connected to a first electrical battery line and wherein a second electrical interface line is connected to a second electrical battery line.

24. The battery-backed charger according to claim 17, wherein the battery assembly has a modular structure such that each battery pack of the battery assembly is exchangeable connected to the battery-backed charger, such that it is exchangeable without removing another battery pack from the battery assembly.

25. The battery-backed charger according to claim 21, wherein the battery DC/DC converter of the at least one electrical battery line is arranged in the housing in a different compartment from a battery compartment.

26. The battery-backed charger according to claim 17, further comprising a cooling assembly configured to regulate a temperature of at least one component of the battery-backed charger during its operation.

27. The battery-backed charger according to claim 26, wherein the cooling assembly is arranged in a cooling compartment within the housing and wherein the cooling assembly comprises:
a heat exchanger configured to provide a controlled exchange of heat from a cooling fluid and configured to cool the battery assembly during operation of the battery-backed charger, to a ventilation fluid within the cooling compartment which is configured to absorb the heat from the cooling fluid during operation of the battery-backed charger; and
a ventilator configured to provide a controlled exchange of the ventilation fluid within the cooling compartment with a surrounding of the battery-backed charger.

28. The battery-backed charger according to claim 27, wherein a battery compartment is arranged in the housing between the cooling compartment and an interface compartment, which comprises at least partially the components of the connection interfaces.

29. The battery-backed charger according to claim 18, wherein the housing of the battery-backed charger includes individual compartments and provides a separate access to the individual compartments of the housing from outside through the housing.

30. The battery-backed charger according to claim 17, wherein the housing has at least partially a shape of a container.

31. The battery-backed charger according to claim 17, wherein the vehicle connection interface comprises a plurality of charging interfaces using the MCS-standard and/or a plurality of charging interfaces using the CCS-standard.

32. The battery-backed charger according to claim 17, wherein the battery-backed charger comprises at least one of:
a grid switching arrangement, which is configured to selectively couple or uncouple the available electrical grids; or
a vehicle switching arrangement, which is configured to selectively couple or uncouple components of the battery-backed charger for a desired electrical energy transfer between the battery-backed charger and the electrical vehicle.

33. The battery-backed charger according to claim 21, wherein the battery assembly comprises five to twenty electrical battery lines, each electrical battery line comprising the respective battery DC/DC converter and the respective battery pack.

34. The battery-backed charger according to claim 21, wherein the battery assembly comprises nine or sixteen electrical battery lines, each electrical battery line comprising the respective battery DC/DC converter and the respective battery pack.

35. The battery-backed charger according to claim 17, wherein the vehicle connection interface comprises two charging interfaces using the MCS-standard and/or two charging interfaces using the CCS-standard.
